(19) United States
(12) Patent Application Publication
(10) Pub. No.: US 2024/0428463 A1
(43) Pub. Date: Dec. 26, 2024

(54) Systems and Methods for Improving Compression of 3D Textures Using Unmapped Pixels

(71) Applicant: Six Impossible Things Before Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/425,525

(22) Filed: Jan. 29, 2024

Related U.S. Application Data
(60) Provisional application No. 63/509,441, filed on Jun. 21, 2023.

(51) Int. Cl. G06T 9/00; G06T 15/04

(52) U.S. Cl. CPC G06T 9/00; G06T 15/04

(57) ABSTRACT

The systems and methods described herein provide improved texture compression techniques by identifying pixels of a texture that are not used or needed for rendering a three-dimensional model and taking into account the “unused” nature of those pixels. The unused pixels may be identified based on the UV mapping of the texture onto the three-dimensional model. According to one aspect of the invention, the systems and methods described herein may modify a compression method (or compression algorithm) to be used to treat the unused pixels as “wildcards” that may produce any color when decoded (and therefore the most efficiently coded representation can be chosen for such unused pixels). According to another aspect of the invention, the systems and methods described herein may pre-process unused pixels to enable the compression method to work more efficiently.

### RELATED APPLICATIONS

This application claims priority to U.S. Provisional Application No. 63/509,441, entitled “Method for Improving Compression of Textures,” filed on Jun. 21, 2023, the contents of which are incorporated herein by reference in their entirety.

### FIELD OF THE DISCLOSURE

The systems and methods described herein relate to improvements to the compression of textures to be used for rendering a three-dimensional model in computer-generated graphics.

### BACKGROUND

In computer graphics, textures are frequently used to render the surface of a computer-generated graphic or three-dimensional model. Textures can be uniform, such as a brick wall, or irregular, such as wood grain or marble. Textures are typically mapped to the surface of a three-dimensional model using “UV mapping.” As discussed herein, UV mapping is a process of projecting a two-dimensional (2D) image onto a three-dimensional (3D) surface to facilitate textured 3D objects. A UV map is a two-dimensional representation of the vertices of a three-dimensional model. When a three-dimensional model is rendered, a UV map may be used to project textures-which may be generated in two-dimensional applications-onto the surface of the three-dimensional model. The letters “U” and “V” denote the axes of the two-dimensional texture because “X”, “Y”, and “Z” are already used to denote the axes of the three-dimensional object in model space. UV texture mapping enables the generation of three-dimensional models rich in color and detail. As three-dimensional applications become more visually complex, so too do the textures used to render three-dimensional models.

In three-dimensional applications, textures are typically compressed by reducing the amount of Video RAM (VRAM) storage needed or used to store the texture (e.g., using method(s) associated with S3 Texture Compression (S3TC), Ericsson Texture Compression (ETC), PowerVR Texture Compression (PVRTC), or Adaptive Scalable Texture Compression (ASTC)). In other applications, images may be compressed, for example, to reduce the storage and/or transfer size of the textures (e.g., using texture compression method(s) listed above and/or methods associated with file formats such as PNG, JPEG, WebP, AVIF, or JPEG XL).

Notably, when rendering a three-dimensional model, not all of the pixels of a texture are typically used. Conventionally, all (or most) of these “unused pixels” are made black to indicate that the pixels are unused. However, doing so often causes high contrast (i.e., a large color difference) with neighboring pixels. When compressing images, high contrast transitions between neighboring pixels may increase the compressed size of a texture (for a given visual quality of compressed image) or reduce the visual quality of the texture (for a given size). As such, there is a need in the art for an improved technique for compressing textures to be used when rendering a computer-generated three-dimensional model.

### SUMMARY OF THE DISCLOSURE

This disclosure relates to systems and methods for improving texture compression by identifying pixels of a texture that are not used or needed for rendering a three-dimensional model and taking into account the “unused” nature of those pixels. The unused (unmapped) pixels may be identified based on the UV mapping of the texture onto the three-dimensional model. With the unused pixels identified, texture compression may be improved by modifying the compression method (or compression algorithm) to account for the unused nature of the unused pixels or by pre-processing the unused pixels so that the compression method operates more efficiently.

According to one aspect of the invention, the systems and methods described herein may use a compression method, which is modified to treat the unused pixels as “wildcards” that may produce any color when decoded (and the modified method may use the values for these pixels to optimize image compression). In implementations in which the compression method used is a previously-encountered pattern compression method (such as a run-length encoding-based method or a method the same as or similar to the DEFLATE compression method associated with the PNG file format or—more generally—any method which uses one of the LZ family of compression methods, such as LZ77, LZ78, LZMA, LZ4, and so on), the compression method may be modified to allow the unused pixels to match to any pixel in a previously encoded pattern of pixels, thereby improving maximum-available-match length, which may in turn improve compression. For example, when a method the same as or similar to the compression method associated with the JPEG family of file formats (including, but not limited to, JPEG, JPEG2000, JPEG XR, or JPEG XL) or an AV1-based image compression method (such as AVIF) is used, a run-length coding may be used for encoding so-called AC coefficients of discrete cosine transforms (DCTs). In such cases, the method may be modified to assume AC coefficients for unused pixels are zeros, which may be encoded very efficiently using the variation of run-length coding used in these methods. In implementations in which the compression method used is a difference-encoding compression method (such as a method the same as or similar to the compression method associated with the JPEG family of file formats, including, but not limited to, JPEG, JPEG2000, JPEG XR, or JPEG XL, or an AV1-based image compression method such as AVIF), the compression method may be modified to assume the difference between unused pixels and other pixels is the optimal difference (e.g., the difference which results in the smallest number of output bits) for that compression method. For example, for the methods listed above, the method may be modified to assume the difference between a DC coefficient corresponding to an unused pixel (and/or a whole DCT block of unused pixels) and a previous DC coefficient is zero.

Note that while a compression method may be modified, in some embodiments a standard (un-modified) method may still be used for subsequent decompression. This may produce seemingly arbitrary values for unused pixels, but as the pixels are unused, they may not be visible on the 3D rendering.

According to another aspect of the invention, the systems and methods described herein may pre-process unused pixels to enable the compression method to work more efficiently. For example, the unused pixels may be modified to minimize the contrast between unused pixels and adjacent pixels. In some implementations, a single color may be identified to fill all unused pixels. For example, a single color to fill all the unused pixels may be identified by determining an average color of all used pixels of the texture, by determining an average color of the used pixels bordering at least one of the unused pixels, by determining the most frequently encountered color among all the pixels in the texture, or by applying the selected compression method to all available colors to identify the color that produces the optimal compressed image (e.g., based on compressed image size and/or compressed image quality). In other implementations, colors may be selected for individual unused pixels one-by-one. For example, the color to be used to fill an individual unused pixel may be identified by determining an average pixel color of the pixels bordering the unused pixel or by determining a most frequent color among the pixels bordering the unused pixel.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to compress textures to be used for rendering a three-dimensional model, according to one or more aspects described herein;

FIG. 2 depicts a flow diagram of an example of a method for improving texture compression by modifying the compression method to account for the unused nature of unused pixels, according to one or more aspects described herein; and

FIG. 3 depicts a flow diagram of an example of a method for improving texture compression by pre-processing unused pixels, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

The invention described herein relates to systems and methods for improving texture compression by taking advantage of pixels of the texture that are not used or needed for rendering a three-dimensional model. As described herein, not all of the pixels of a texture are typically used when rendering a three-dimensional model. Because these pixels are not used or needed to render the three-dimensional model, it does not matter what color these unused pixels are when decoded. The systems and methods described herein may take into account the “unused” nature of these pixels by modifying a chosen compression method to consider each unused pixel to be a pixel optimal for compression by that particular compression method or by pre-processing the unused pixels to reduce contrast with adjacent pixels, thereby improving compression of the texture itself.

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

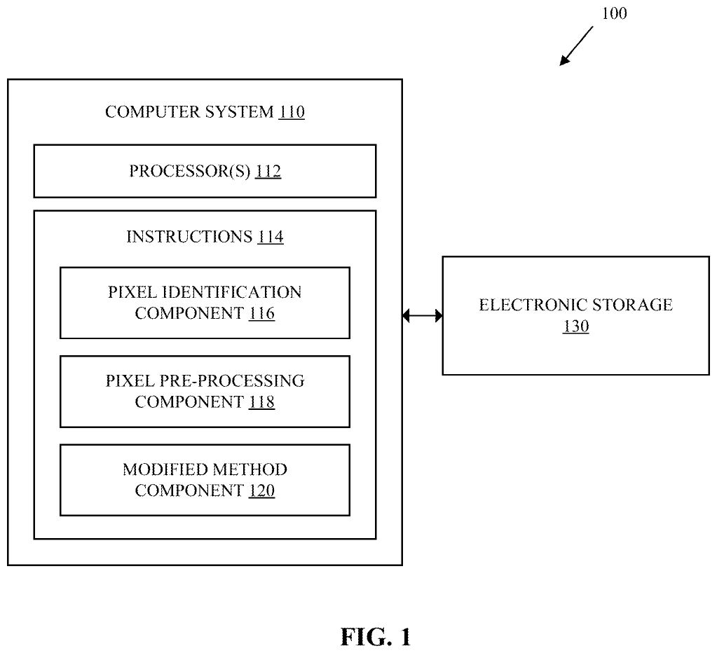

FIG. 1 illustrates an example of a system 100 for compressing textures to be used for rendering a three-dimensional model, according to one or more aspects described herein. In various implementations, system 100 may include a computer system 110, electronic storage 130, and/or other components. In various implementations, computer system 110 may include one or more physical computer processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of pixel identification component 116, pixel pre-processing component 118, modified method component 120, and/or other computer program components. As used herein, for convenience, the various computer readable instructions 114 will be described as performing an operation, when, in fact, the various instructions program the processor(s) 112 (and therefore system 100) to perform the operation.

In various implementations, pixel identification component 116 may be configured to identify unused pixels of the texture. Unused pixels of a texture may comprise pixels of the texture that are not used or needed for rendering a three-dimensional model. In various implementations, pixel identification component 116 may be configured to identify unused pixels of the three-dimensional model based on a UV mapping of the texture onto the three-dimensional model. For example, pixel identification component 116 may be configured to obtain and analyze a UV mapping of the texture onto the three-dimensional model.

In various implementations, pixel identification component 116 may be configured to enumerate all the polygons in a mesh that corresponds to a texture. For each polygon, pixel identification component 116 may then be configured to take all the UV coordinates of the mesh vertices corresponding to the polygon vertices and identify corresponding polygons on the texture (using UV coordinates). In some implementations, pixel identification component 116 may then be configured to mark all the pixels on the texture which belong to the corresponding polygons as “used.” After the enumeration of the polygons is completed, pixel identification component 116 may be configured to mark as “unused” all the pixels which were not marked as “used.”

In some implementations, pixel identification component 116 may be configured to identify unused pixels of the texture using a monochrome bitmap of the three-dimensional model. For example, a monochrome bitmap of the three-dimensional model may depict all used pixels in a single color (e.g., black) with all the unused pixels remaining white (or vice versa). In some implementations, pixel identification component 116 may be configured to identify the unused pixels of a texture based on the pixels depicted (or not depicted) in the monochrome bitmap of the three-dimensional model.

In various implementations, pixel pre-processing component 118 may be configured to pre-process the unused pixels of the texture so that the compression method(s) to be used work more efficiently. For example, to pre-process the unused pixels of the texture, the pixel pre-processing component 118 may be configured to fill the unused pixels with one or more colors prior to compression so that color difference (or contrast) with adjacent pixels is minimized. In various implementations, pixel pre-processing component 118 may be configured to determine the one or more colors to use to fill the unused pixels based on other pixel(s) of the texture and/or the compression method selected to compress the texture. In some implementations, pixel pre-processing component 118 may be configured to fill all unused pixels with the same color. In some implementations, pixel pre-processing component 118 may be configured to fill the unused pixels one-by-one to minimize gradients for individual pixels.

In some implementations, pixel pre-processing component 118 may be configured to identify the color to be used to fill all the unused pixels by determining an average pixel color. For example, pixel pre-processing component 118 may be configured to determine an average color of all used pixels, an average color of the used pixels bordering the unused pixels, an average color of another subset of the used and/or unused pixels, or the most frequently encountered color among all the pixels in the texture.

In some implementations, pixel pre-processing component 118 may be configured to identify the color to be used to fill all the unused pixels by searching among available colors and applying a compression method to be used to compress the texture to determine which color produces the best image in terms of size and/or image quality. For example, the one or more metrics used to determine which color produces the best image may comprise peak signal-to-noise ratio (PSNR), mean-squared error (MSE), structural similarity index measure (SSIM), feature similarity (FSIM) index, human visual system (HVS) model, universal image quality index (UIQI), and/or one or more other compressed image quality metrics. In some implementations, pixel pre-processing component 118 may be configured to perform an exhaustive search of colors. For example, pixel pre-processing component 118 may be configured to search all colors in RGBA 32-bit space, in full RGBA 16-bit space, in full RGB 32-bit space, or in full RGB 16-bit space. In some implementations, pixel pre-processing component 118 may be configured to reduce the search space and optimize the search using a genetic algorithm, simulated annealing, hill climbing, and/or one or more other optimized search methods.

In some implementations, pixel pre-processing component 118 may be configured to identify the color to be used to fill unused pixels by selecting colors for individual unused pixels one-by-one or in groups to minimize the color difference between adjacent pixels. For example, pixel pre-processing component 118 may be configured to identify the color to be used to fill a single unused pixel or a group of unused pixels based on the colors of pixels bordering the unused pixel(s). As described herein, the pixels bordering the unused pixel(s) may comprise used pixels and/or unused pixels already filled using the techniques described herein. In some implementations, pixel pre-processing component 118 may be configured to identify the color to be used to fill a single unused pixel or a group of unused pixels by determining an average pixel color (e.g., in RGB or any other color space) of the pixels bordering the unused pixel(s). In some implementations, pixel pre-processing component 118 may be configured to identify the color to be used to fill a single unused pixel or a group of unused pixels by identifying a most frequent color among the pixels bordering the unused pixel(s). If there is not a single most frequently appearing color among the pixels bordering the unused pixel(s) (e.g., if two or more colors are “tied”), pixel pre-processing component 118 may be configured to choose between the most frequently appearing colors by determining a global number of the used and already-filled pixels which have at least one unused pixel among its adjacent pixels for each of the “tied” colors. Pixel pre-processing component 118 may be configured to repeat one or more of these operations until all the unused pixels are filled.

In some embodiments, pixel pre-processing component 118 may be absent.

In various implementations, modified method component 120 may be configured to take into account the unused nature of the unused pixels. In various implementations, modified method component 120 may be configured to modify a pre-existing compression method in such a manner that the modified compression method considers each unused pixel to be a pixel optimal for compression by that particular compression method. As such, the compression method may be modified to treat an unused pixel as a “wildcard.” In some implementations, the modified compression method may encode individual unused pixels differently. Accordingly, the unused pixels may comprise pixels of variable color when decoded. Based on the existing compression method to be used, modified method component 120 may be configured to modify the compression method to allow unused pixels to match to any pixel in a previously encoded pattern of pixels, to choose a difference that is most optimal for compression when encoding an unused pixel as a difference from another pixel, and/or otherwise modify the compression method to take advantage of the unused nature of the unused pixels.

Various methods may be used to compress a texture. In some implementations, a compression method may be used that encodes pixels by referring to previously encountered patterns (referred to herein as “previously-encountered pattern compression methods”). Examples of previously-encountered pattern compression methods may include the DEFLATE method used for the PNG file format and, more generally, any run-length encoding-based methods, LZ77-based methods, and other similar methods. For example, in compression methods using JPEG-like compression (which may include at least the JPEG family of compression methods including JPEG XL, and AV1-based methods such as AVIF), run-length encoding may be used for so-called AC coefficients of DCT transform. In some implementations, a compression method may be used that encodes pixels as a difference from another pixel (referred to herein as “difference-encoding” compression methods). Examples of difference-encoding compression methods may include the method used for the JPEG file format and other similar methods. For example, in compression methods using JPEG-like compression (which may include at least the JPEG family of compression methods including JPEG XL, and AV1-based methods including AVIF), a difference encoding (e.g., differential pulse-code modulation (DPCM) encoding) may be used for so-called DC coefficients of DCT transform. These and other compression methods now known or future developed may be used with the systems and methods described herein.

In implementations in which a previously-encountered pattern compression method is used, modified method component 120 may be configured to modify the compression method such that it allows unused pixels to match to any pixel in a previously encoded pattern. Previously-encountered pattern compression methods may achieve compression by replacing repeated occurrences of data (or patterns) with a reference to a copy of that data previously encountered in the uncompressed data stream. For example, subsequent occurrences of a pattern may be encoded by a pair of numbers indicating simply the number of characters in the pattern (or “length”) and the number of characters behind the subsequent occurrence that the pattern may be found in the uncompressed stream (or “distance”). The pair of numbers may be referred to as a “length-distance pair.” By allowing unused pixels to match to any pixel in a previously encoded pattern, the maximum-available-match length may be increased (because the modified compression method is able to use unused pixels to identify matches of longer patterns), thereby improving compression. This may apply, for example, to DEFLATE (and more generally, all LZ-like) methods, which are used, in particular, in PNG file format.

In some implementations (which may include many popular lossy image compression formats, including, but not limited to, JPEG-like formats or AV1-based formats), previously-encountered encoding may include run-length encoding of so-called AC coefficients of DCT transform (which may be scanned in zig-zag order). In such cases, the method may be modified so that for unused pixels, AC coefficients may be assumed to be zeros (which may be efficiently encoded by specific variations of run-length encodings used by these formats).

In implementations in which a difference-encoding compression method is used, modified method component 120 may be configured to modify the compression method to choose a difference that is most optimal for compression when encoding an unused pixel. For example, in methods similar to the methods used for the JPEG file format (as well as a wide range of other lossy image compression methods, including methods based on AV1), DPCM encoding may be used for so-called DC coefficients of DCTs, wherein one or more DC coefficients may be encoded as a “difference from previous DC coefficient.” With these methods, zero difference from a previous pixel may be the most optimal for compression. As such, to improve compression, modified method component 120 may be configured to modify the method to assume the difference between a DC coefficient corresponding to an unused pixel (and/or a whole DCT block which contains one or more unused pixels) and a previous DC coefficient is zero. In some implementations, modified method component 120 may be configured to assume zero-difference DC coefficients only if some (or most) pixels in a whole DCT block are unused. In other implementations, modified method component 120 may be configured to assume zero-difference DC coefficients only if such assumption leads to reduction in overall encoding size.

In some implementations, modified method component 120 may use an original algorithm without modifications. This may be used, for example, in implementations in which pixel pre-processing component 118 is present.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., computer system 110 or processor 112). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor 112, information received remotely, and/or other information that enables system 100 to function properly. For example, electronic storage 130 may store information relating to one or more three-dimensional models, one or more textures, one or more existing compression methods (i.e., one or more existing compression algorithms) to be used to compress a texture, one or more compression algorithms modified according to techniques described herein, one or more existing decompression methods (i.e., one or more existing decompression algorithms) to be used to decompress a compressed image or texture, and/or other information.

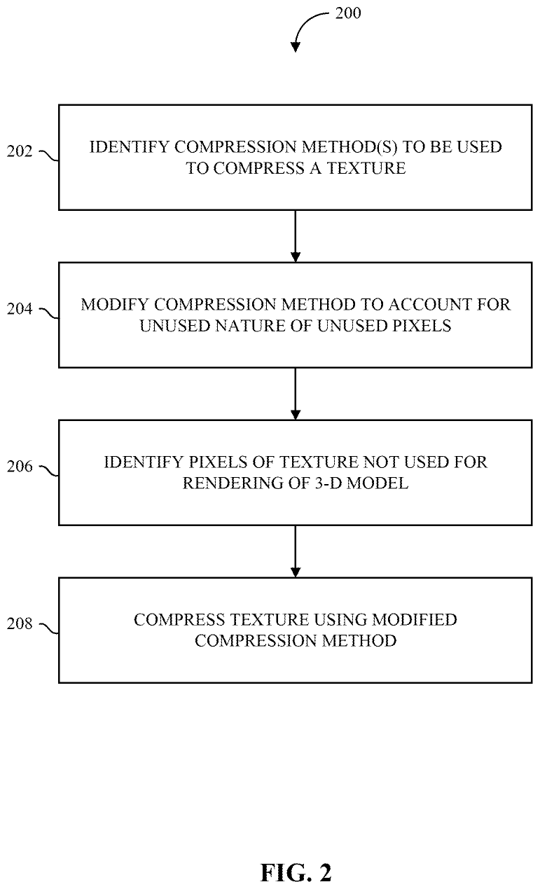

FIG. 2 illustrates an example of a process 200 for improving texture compression by modifying the compression method to account for the unused nature of unused pixels, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components described in detail above.

In an operation 202, process 200 may include obtaining an indication of one or more compression methods to be used to compress a texture. In some implementations, the one or more compression methods to be used to compress the texture may comprise at least one method that compresses the texture by reducing VRAM size taken up by the texture or by reducing the transfer size of the texture. For example, the one or more compression methods may include at least one of a method associated with S3TC, ETC, and PVRTC and/or a method associated with file formats such as PNG, JPEG, WebP, AVIF, or JPEG XL. In various implementations, the indication of the one or more compression methods to be used to compress the texture may be based on user input selecting one or more compression methods or may be a pre-defined set of one or more default compression methods used by system 100 to compress a texture.

In an operation 204, process 200 may include modifying the compression method to be used to take into account the unused nature of the unused pixels. For example, the existing compression method that would have been used to compress the texture may be modified to consider each unused pixel to be a pixel that would be optimal for compression by that particular compression method. In some implementations, the modified compression method may encode individual unused pixels differently. Accordingly, the unused pixels may comprise pixels of variable color when decoded. In implementations in which a previously-encountered pattern compression method is used (such as a method the same as or similar to the compression method associated with the PNG file format), the compression method may be modified to allow the unused pixels to match to any pixel in a previously encoded pattern of pixels. In other words, the compression method may be modified to treat an unused pixel as a “wildcard.” In implementations in which run-length encoding is used, the compression method may be modified to assume run-length-encoded values for unused pixels are values which are most efficiently compressed with the rest of the method. For example, if run-length coding is used for encoding so-called AC coefficients of DCTs (which is a technique used by a wide range of lossy compression methods, including, but not limited to, the JPEG family of methods including JPEG XL, and AV1-based methods such as AVIF), the method may be modified to assume that AC coefficients for unused pixels are zeros (as zeros may be efficiently encoded by the coding commonly used in such methods). In implementations in which the compression method used encodes pixels as a difference from another pixel, the compression method may be modified to assume the difference between unused pixels and other pixels is the optimal difference for that compression method. For example, with existing compression methods that use differential encoding (such as DPCM encoding) for DC coefficients of DCTs (which is used by a wide range of lossy compression methods, including, but not limited to, the JPEG family of compression methods including JPEG XL, and AV1-based methods such as AVIF), the method may be modified to assume that the DC coefficient for an unused pixel (and/or the whole DCT block which contains one or more unused pixels) has zero difference from a previously encountered DC coefficient, as this may be the most optimal for compression. As such, in some implementations, the compression method may be modified to assume the difference between unused pixels and other pixels is zero. In some implementations, operation 204 may be performed by a processor component the same as or similar to modified method component 120 (shown in FIG. 1 and described herein).

In an operation 206, process 200 may include identifying unused pixels of the texture. Unused pixels of a texture may comprise pixels of the texture that are not used or needed for rendering a three-dimensional model. In some implementations, the unused pixels of the texture may be identified based on a UV mapping of the texture onto the three-dimensional model. For example, a UV mapping of the texture onto the three-dimensional model may be obtained and analyzed. Based on the analysis of the UV mapping of the texture, the pixels of the texture that are mapped to the three-dimensional model may be identified (for example, as described herein with respect to pixel identification component 116), and all the remaining pixels of the texture may be marked as unused. In some implementations, operation 206 may be performed by a processor component the same as or similar to pixel identification component 116 (shown in FIG. 1 and described herein).

In an operation 208, process 200 may include compressing the texture using the modified compression method. In some implementations, operation 208 may be performed by a processor component the same as or similar to modified method component 120 (shown in FIG. 1 and described herein).

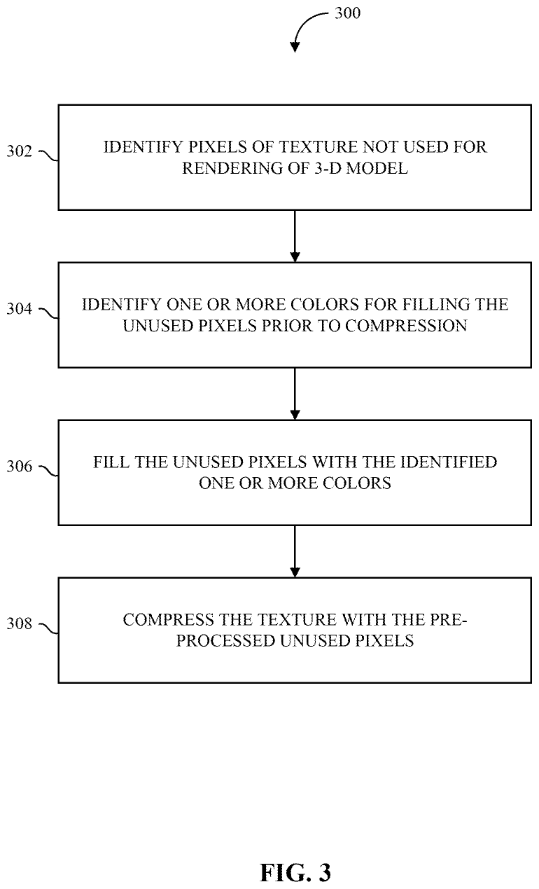

FIG. 3 illustrates an example of a process 300 for improving texture compression by pre-processing unused pixels, according to one or more aspects described herein. The operations of process 300 presented below are intended to be illustrative and, as such, should not be viewed as limiting. In some implementations, process 300 may be accomplished with one or more additional operations not described, and/or without one or more of the operations discussed. In some implementations, two or more of the operations of process 300 may occur substantially simultaneously. The described operations may be accomplished using some or all of the system components described in detail above.

In an operation 302, process 300 may include identifying unused pixels of the texture. Unused pixels of a texture may comprise pixels of the texture that are not used or needed for rendering a three-dimensional model. In some implementations, the unused pixels of the texture may be identified based on a UV mapping of the texture onto the three-dimensional model. For example, a UV mapping of the texture onto the three-dimensional model may be obtained and analyzed. Based on the analysis of the UV mapping of the texture, the pixels of the texture that are mapped to the three-dimensional model may be identified, and all the remaining pixels of the texture may be marked as unused. In some implementations, the unused pixels of the texture may be identified as described herein with respect to pixel identification component 116. In some implementations, operation 302 may be performed by a processor component the same as or similar to pixel identification component 116 (shown in FIG. 1 and described herein).

In an operation 304, process 300 may include identifying one or more colors to be used to fill the unused pixels prior to compression. In various implementations, the one or more colors to be used to fill the unused pixels may be identified based on one or more other pixels of the texture and/or the compression method to be used to compress the texture. In some implementations, a single color may be identified to fill each unused pixel. In some implementations, the single color used to fill the unused pixels may be identified by determining an average color of all used pixels of the texture, by determining an average color of the used pixels bordering at least one of the unused pixels, or by determining the most frequently encountered pixel among all the pixels in the texture. In other implementations, the single color used to fill the unused pixels may be identified by searching among all available colors to identify a color producing an optimal compressed image. For example, the selected compression method may be applied against images corresponding to each of the available colors, and the optimal compressed image produced may be identified based on compressed image size, compressed image quality, or some combination of compressed image size and compressed image quality. In some implementations, different colors to be used to fill different unused pixels may be identified one-by-one or in groups. For example, the color to be used to fill a given unused pixel or a group of unused pixels may be identified based on the pixels bordering the unused pixel(s). In some implementations, the color used to fill a given unused pixel or a group of unused pixels may be identified by determining an average color of the pixels bordering the unused pixel(s). In other implementations, the color used to fill a given unused pixel or a group of unused pixels may be identified by identifying a most frequent color among the pixels bordering the unused pixel(s). In some implementations, operation 304 may be performed by a processor component the same as or similar to pixel pre-processing component 116 (shown in FIG. 1 and described herein).

In an operation 306, process 300 may include filling the unused pixels with the identified one or more colors to reduce contrast with adjacent pixels. In some implementations, the unused pixels may be filled with a single color. In other implementations, the unused pixels may be filled with different colors. For example, in some implementations, the unused pixels may be filled one-by-one or in groups to minimize color difference between adjacent pixels. In some implementations, operation 306 may be performed by a processor component the same as or similar to pixel pre-processing component 116 (shown in FIG. 1 and described herein).

In an operation 308, process 300 may include compressing the texture with the pre-processed unused pixels. In some implementations, operation 308 may be performed by a processor component the same as or similar to modified method component 120 (shown in FIG. 1 and described herein).

In some implementations, difference-encoding methods may include methods that use predictors. In such compression methods, a difference from a predicted value (also known as “error”) may be encoded (e.g., using an entropy coder). This approach is common, for example, for lossless variations of different methods, such as JPEG or JPEG XL. In implementations in which a difference-encoding compression method is used, modified method component 120 may be configured to modify the method to assume zero “error” for unused pixels.

In some implementations, instead of (or in addition to) utilizing modified versions of difference-encoding methods and/or previous-encountered-pattern methods, modified method component 120 may be configured to use techniques which aim to modify pixel data to improve efficiency of a subsequent entropy coding method. In one example, if pixels are coded using entropy coding (e.g., using a method used for the PNG file format, including color-indexed PNG) modified method component 120 may be configured to encode “unused” pixels with a value which is among the most frequently encountered values of all the used pixels in the image. This may improve statistical distribution of the data which is subsequently fed to the entropy decoder, which in turn may increase efficiency of entropy coding.

In some implementations, a combination of two aspects of the present disclosure may be used. For example, in some implementations, the unused pixels that border used pixels may be pre-processed as described herein with respect to pixel pre-processing component 118 (for example, filling by the unused pixels with an average color for all pixels or for all used pixels bordering unused pixels), and a method may be modified as described herein with respect to modified method component 120 (and/or step 204) to encode all the other unused pixels (i.e., those which do not border used ones) to minimize a size of the resulting image. This may be useful, for example, to avoid unpleasant visual glitches if rounding errors cause rendering to address those pixels which are immediately outside of the area specified by UV mapping, while still providing improved compression.

In some implementations, an additional step of “UV splitting” may be introduced before one or more techniques described in present disclosure are applied. For example, in some embodiments, a texture may be split into several textures (which may be referred to herein as “UV-split textures”), with each of the textures containing one or more contiguous areas containing used pixels, and splits going over unused pixels (where used and unused pixels may be identified, for example, as described herein with respect to pixel identification component 116). In some implementations, each of the textures may be compressed separately using methods described herein. To allow the UV-split textures to be used for rendering three-dimensional objects, the UV split textures may either be combined back together, or UV mapping of the mesh may be modified to refer to the UV-split textures. In some implementations, different methods may be used to compress different UV-split textures. For example, in an example implementation, one or more UV-split textures may be compressed using an existing or modified version of the JPEG XL method, and one or more UV-split textures may be compressed using an existing or modified version of the AVIF method.

In some implementations, the systems and methods described herein may be used to compress images with transparency that may or may not comprise 3D textures. In such implementations, if a pixel is completely transparent (or almost-completely transparent (i.e., having transparency above pre-specified threshold)), the color of the pixel may be not important for subsequent image uses (such as rendering). In such cases, the transparent or almost-transparent pixels may be treated the same way as unused pixels are treated as described herein (for example, using one or more of the techniques described herein with respect to modified method component 120 and/or step 204). In some implementations, if a 3D texture with transparency is compressed using one or more techniques described herein, both unused pixels obtained by analysis of the UV mapping and transparent pixels (or almost-completely transparent pixels) may be treated as unused pixels for the purposes of a modified compression algorithm as described, for example, with reference to modified method component 120 and/or step 204.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application-such as by using any combination of digital processors, analog processors, digital circuits designed to process information, central processing units, graphics processing units, microcontrollers, microprocessors, field programmable gate arrays (FPGAs), application specific integrated circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, computer system 110 may include a plurality of individual components (e.g., computer devices) each programmed with at least some of the functions described herein. In this manner, some components of computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions. Any communication medium may be used to facilitate interaction between any

components of system 100. One or more components of system 100 may communicate with each other through hard-wired communication, wireless communication, or both. In various implementations, one or more components of system 100 may communicate with each other through a network. For example, computer system 110 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method of improving texture compression by modifying the compression method to account for the unused nature of unused pixels, the method comprising:
identifying unused pixels of a texture, wherein the unused pixels comprise pixels of the texture that are not used for rendering a three-dimensional model; and
compressing the texture using a modified compression method, wherein the modified compression method comprises a compression method modified to automatically associate the unused pixels with certain values to optimize compression of the texture.

2. The computer-implemented method of claim 1, wherein the unused pixels of the texture are identified based on a UV mapping of the texture onto the three-dimensional model.

3. The computer-implemented method of claim 2, wherein identifying the unused pixels of the texture based on a UV mapping of the texture onto the three-dimensional model comprises:
identifying pixels of the texture that are mapped to the three-dimensional model based on the UV mapping of the texture onto the three-dimensional model; and
marking all remaining pixels of the texture as unused.

4. The computer-implemented method of claim 1, wherein the compression method comprises a previously-encountered pattern compression method, and wherein modifying the compression method comprises modifying the previously-encountered pattern compression method to allow the unused pixels to match to any pixel in a previously encoded pattern of pixels.

5. The computer-implemented method of claim 4, wherein previously-encountered pattern compression method is a DEFLATE compression method.

6. The computer-implemented method of claim 4, wherein previously-encountered pattern compression method comprises a run-length coding method.

7. The computer-implemented method of claim 6, wherein the run-length coding method is used to encode AC coefficients of a discrete cosine transforms, and wherein modifying the compression method comprises modifying the compression method to assume AC coefficients for unused pixels are zeros.

8. The computer-implemented method of claim 7, wherein the compression method is a JPEG method.

9. The computer-implemented method of claim 7, wherein the compression method is a JPEG XL method.

10. The computer-implemented method of claim 7, wherein the compression method is an AVIF method.

11. The computer-implemented method of claim 1, wherein the compression method comprises a difference-encoding compression method, and wherein modifying the compression method comprises modifying the compression method to assume the difference when encoding the unused pixels is zero.

12. The computer-implemented method of claim 11, wherein the compression method uses difference-encoding to encode DC coefficients of discrete cosine transforms, and wherein modifying the compression method comprises modifying the compression method to assume DC coefficients for unused pixels have a zero difference from previously-encountered DC coefficients.

13. The computer-implemented method of claim 12, wherein the compression method is a JPEG method.

14. The computer-implemented method of claim 12, wherein the compression method is a JPEG XL method.

15. The computer-implemented method of claim 12, wherein the compression method is an AVIF method.

16. A system for performing texture compression by modifying the compression method to account for the unused nature of unused pixels, the system comprising:
one or more processors configured by computer readable instructions to:
identify unused pixels of a texture, wherein the unused pixels comprise pixels of the texture that are not used for rendering a three-dimensional model; and
compress the texture using a modified compression method, wherein the modified compression method comprises a compression method modified to automatically associate the unused pixels with certain values to optimize compression of the texture.

17. The system of claim 16, wherein the unused pixels of the texture are identified based on a UV mapping of the texture onto the three-dimensional model.

18. The system of claim 17, wherein to identify the unused pixels of the texture based on a UV mapping of the texture onto the three-dimensional model, the one or more physical computer processors are configured to:
identify pixels of the texture that are mapped to the three-dimensional model based on the UV mapping of the texture onto the three-dimensional model; and
mark all remaining pixels of the texture as unused.

19. The system of claim 16, wherein the compression method comprises a previously-encountered pattern compression method, and wherein to modify the compression method, the one or more physical computer processors are configured to:
modify the previously-encountered pattern compression method to allow the unused pixels to match to any pixel in a previously encoded pattern of pixels.

20. The system of claim 19, wherein previously-encountered pattern compression method is a DEFLATE compression method.

21. The system of claim 19, wherein previously-encountered pattern compression method comprises a run-length coding method.

22. The system of claim 21, wherein the run-length coding method is used to encode AC coefficients of a discrete cosine transforms, and wherein to modify the compression method, the one or more physical computer processors are configured to:
modify the compression method to assume AC coefficients for unused pixels are zeros.

23. The system of claim 22, wherein the compression method is a JPEG method.

24. The system of claim 22, wherein the compression method is a JPEG XL method.

25. The system of claim 22, wherein the compression method is an AVIF method.

26. The system of claim 16, wherein the compression method comprises a difference-encoding compression method, and wherein to modify the compression method, the one or more physical computer processors are configured to:
modify the compression method to assume the difference when encoding the unused pixels is zero.

27. The system of claim 26, wherein the compression method uses difference-encoding to encode DC coefficients of discrete cosine transforms, and wherein to modify the compression method, the one or more physical computer processors are configured to:
modify the compression method to assume DC coefficients for unused pixels have a zero difference from previously-encountered DC coefficients.

28. The system of claim 27, wherein the compression method is a JPEG method.

29. The system of claim 27, wherein the compression method is a JPEG XL method.

30. The system of claim 27, wherein the compression method is an AVIF method.

31-56. (canceled)
